(19) United States
(12) Patent Application Publication
(10) Pub. No.: US 2011/0139845 A1
(43) Pub. Date: Jun. 16, 2011

(54) TREE STAND TRANSPORTER

(76) Inventors: Clyde E. Rath, Apple Valley, MN (US); Larry D. Rowe, Blooming Prairie, MN (US); Adam P. Bishop, Blooming Prairie, MN (US)

(21) Appl. No.: 12/852,200

(22) Filed: Aug. 6, 2010

Related U.S. Application Data
(60) Provisional application No. 61/231,988, filed on Aug. 6, 2009.

(51) Int. Cl. B60R 9/00; B23P 17/04

(52) U.S. Cl. 224/519; 29/428

(57) ABSTRACT

The present disclosure is directed to a tree stand transporting system and method. In one aspect of the disclosure, the tree stand transporting system includes a vertical support member extending in a generally vertical direction and including a generally horizontally extending hitch connecting portion configured to be received in a receiver hitch on a vehicle. The vertical support member can have a plurality of holes defined in its sidewalls to allow selective placement of an upper support bracket and a lower support bracket using fasteners, such as bolts or pins. The brackets are configured to facilitate securing of the tree stand for transport. Selective placement of the brackets facilitates adaptation of the transport system for a wide variety of tree stand configurations.

### PRIORITY

This application claims benefit of U.S. Provisional Patent Application Ser. No. 61/231,988, filed Aug. 6, 2009, which is hereby incorporated herein by reference in its entirety.

### FIELD

The present invention relates generally to hunting equipment. More particularly, the present invention relates to devices, systems and methods for transporting tree stands.

### BACKGROUND

Tree stands, used for hunting a variety of animals, were originally simple designs constructed of wood or lumber. These stands were permanent, large, difficult to build, and not portable.

Relatively small portable tree stands were then developed. These small portable tree stands were configured to hang on a tree, such as disclosed in U.S. Pat. No. 5,409,083. These hanging-type stands used foot pegs that screwed or dug into the tree. In addition to these types of tree stands being relatively easy to transport, a carrier for use with all terrain vehicles was designed as shown in U.S. Pat. D350,934. However, it was found that these hanging-type stands were difficult to hang on trees, have a very small platform, a very small seat, and are dangerous to sit in and/or standup in, even when wearing the recommended safety restraints.

Given the drawbacks of the hanging-type portable stands, larger tree stands were developed. These larger stands, fitting up to two people, are supported by a free-standing scaffold and have a ladder attached to the front, thereby providing easy access. These larger stands also possess more comfortable seating and are safer to use. While billed as portable, these larger tree stands are far larger and more difficult to move than the hanging-type stands, so hunters often risk leaving them at a given location permanently. Alternatively, hunters may attempt to transport them on small trailers, drag them, move by pickup when possible, or sit on an all terrain vehicle with the platform around them while driving through the woods. None of these transport methods is practical, and worse, is often dangerous. Therefore, there is a need for an improved device, system and method for transporting conventional tree stands.

### SUMMARY

A tree stand transporting system, device and method are disclosed. In one embodiment, the tree stand transport system includes a vertical support member extending in a generally vertical direction. The vertical support member includes a generally vertically extending portion and a generally horizontally extending hitch connecting portion configured to be received in a receiver hitch on a vehicle. A first support bracket can be disposed on the vertical support member. A second support bracket can also be disposed on the vertical support member.

In another embodiment, a method of transporting a tree stand includes inserting a horizontally extending portion of tree stand support member into the receiver hitch of the vehicle. A tree stand is disposed on a first support bracket fastened to the tree stand support member. The tree stand can also be disposed on a second support bracket fastened to the tree stand support member.

In a further embodiment, a tree stand transporting system includes a vertical support member extending in a generally vertical direction and including a generally horizontally extending hitch connecting portion configured to be received in a receiver hitch on a vehicle. The vertical support member can have a plurality of holes defined in its sidewalls to allow selective placement of an upper support bracket and a lower support bracket using fasteners, such as bolts or pins. The brackets are configured to facilitate securing of the tree stand for transport. Selective placement of the brackets facilitates adaptation of the transport system for a wide variety of tree stand configurations.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of a tree stand carrier according to an example embodiment.

FIG. 2 is a perspective view of a tree stand carrier coupled to an all-terrain vehicle according to an example embodiment.

FIG. 3 is a side view of a tree stand carrier coupled to an all-terrain vehicle according to an example embodiment.

FIG. 4 is a perspective view of a support bracket of a tree stand carrier according to an example embodiment.

FIG. 5 is a perspective view of a support bracket of a tree stand carrier according to an example embodiment.

FIG. 6 is a perspective view of a support bracket of a tree stand carrier according to an example embodiment.

FIG. 7A is a top view and FIG. 7B is a side view of a tree stand carrier according to an example embodiment.

FIG. 8A is a top view, FIG. 8B is a side view and FIG. 8C is a front view of a vertical member of a tree stand carrier according to an example embodiment.

FIG. 10A is a top view, FIG. 10B is a side view and FIG. 10C is a front view of a support bracket of a tree stand carrier according to an example embodiment.

FIG. 11A is a perspective view, FIG. 11B is a top view, FIG. 11C is a side view and FIG. 11D is an end view of a receiver hitch assembly according to an example embodiment.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various example embodiments; nevertheless, these example embodiments are not intended to limit the present invention to any specific example, embodiment, environment, application, or particular implementation described herein. Therefore, descriptions of these example embodiments are only provided for purpose of illustration rather than to limit the present invention.

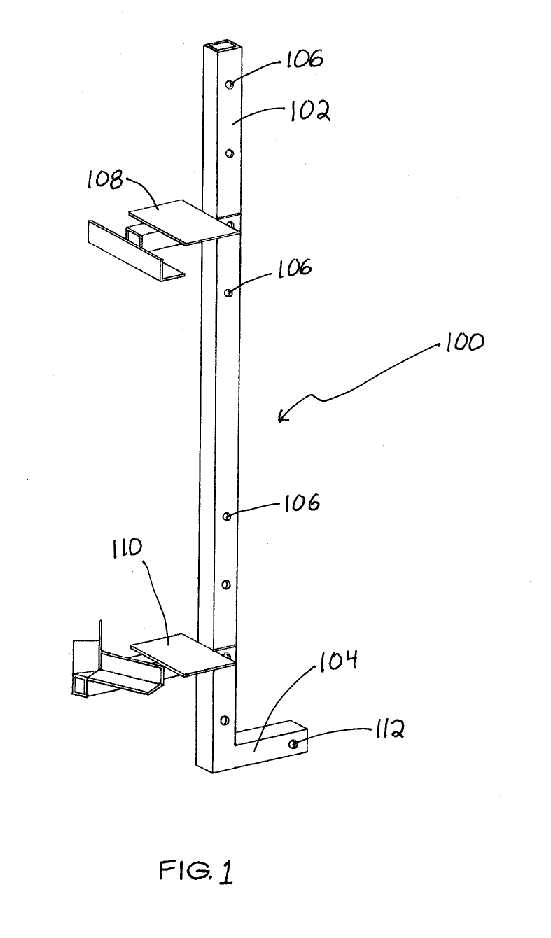

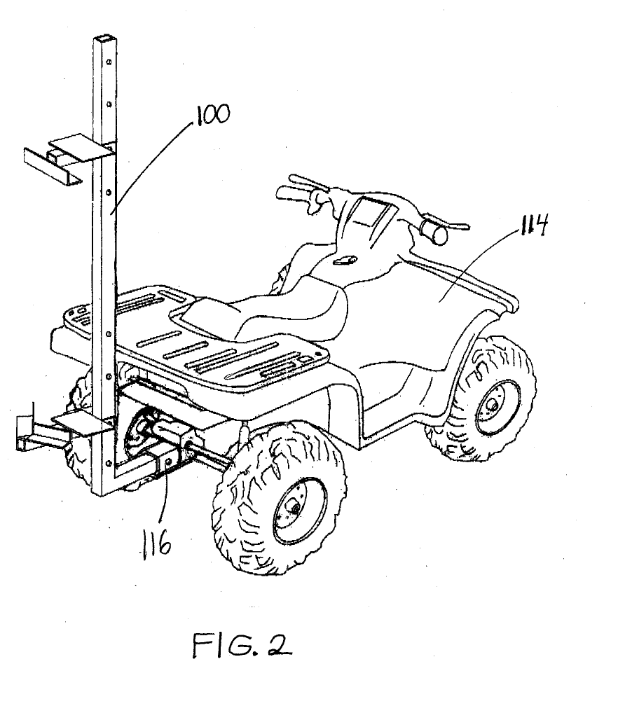

Referring to FIG. 1, a tree stand transporter 100 in one embodiment comprises a vertical support member 102 extending in a generally vertical direction with a generally horizontally extending hitch connecting portion 104. The vertical support member 102 is a tubular member having a square cross section. Although other shapes may be used without departing fro the scope of the invention. The vertical support member has a plurality of holes 106 defined therein on corresponding sides, to which an upper support bracket 108 and a lower support bracket 110 are mounted using fasteners, such as bolts or pins. The plurality of holes 106 facilitate adjustment of locations of the upper 108 and lower 110 brackets to adapt the transporter 100 for use with a variety of tree stand configurations and with a variety of vehicles. A hole 112 is defined in the sidewalls of the hitch connecting portion 104 to facilitate connection with a receiving hitch on a vehicle, such as an all terrain vehicle 114 as shown in FIG. 2.

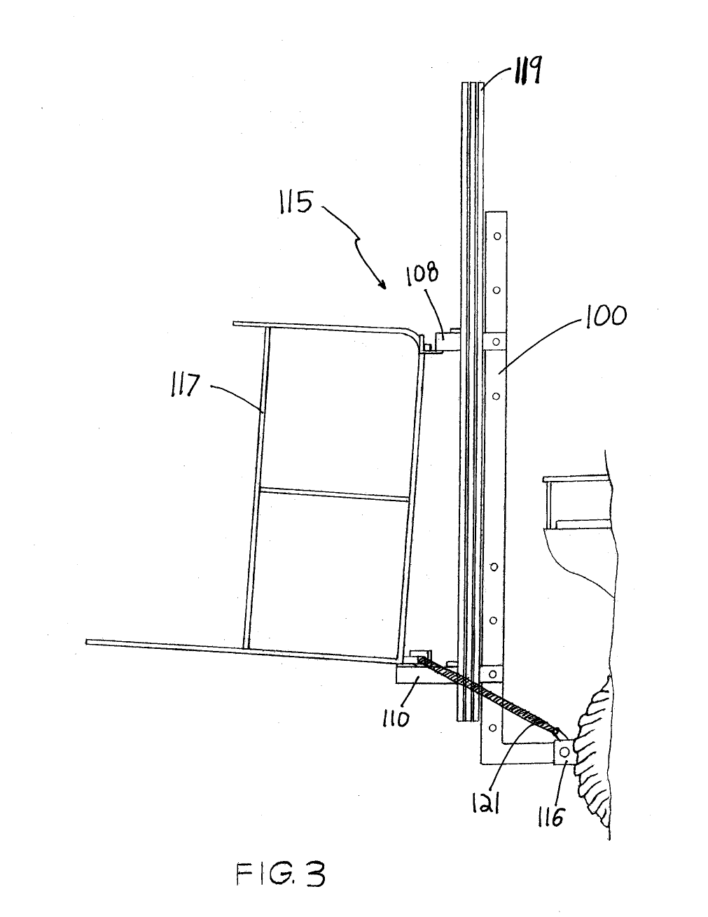

Referring to FIG. 3, a tree stand 115 is shown secured to the tree stand transporter 100 as depicted in FIG. 2. The tree stand platform portion 117 is supported by upper 108 and lower 110 brackets. Tree stand scaffold sections 119 are supported by the upper bracket 108. A tether 121 may be used to further secure the lower portions of the scaffolding sections 119 to the lower bracket 110 and the receiver hitch.

Several different configurations of the upper and lower brackets may be provided as part of a system or kit so that the tree stand carrier can be adapted to carry a wide variety of different tree stand sizes and configurations. A given bracket configuration may be used as either an upper bracket or a lower bracket depending on the configuration of the tree stand to be transported. Also, one or of the upper or lower brackets may be omitted depending on the tree stand configuration. A set of assembly and use instructions may also be provided as part of a kit.

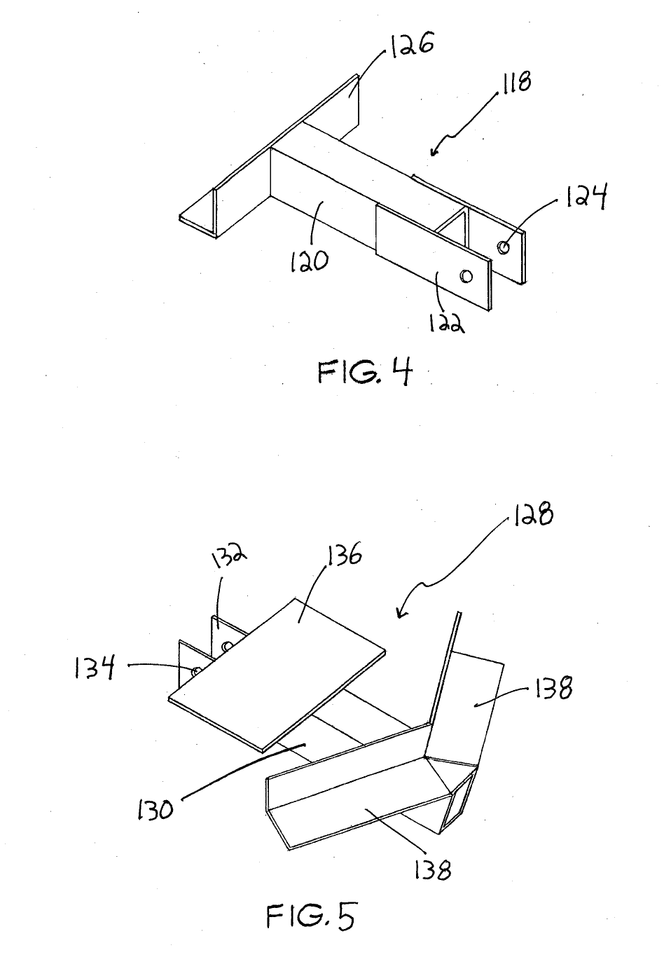

A first embodiment of a bracket 118 is shown in FIG. 4. First bracket 118 comprises a horizontally oriented bracket body 120 comprised of a section of tubing. One end of the body 120 has mounting plates 122 disposed on opposing side surfaces, thereby defining a mounting groove or channel for mounting on the vertical support member. Holes 124 are provided in the mounting plates 122 that correspond to the holes 106 in the vertical member. A fastener, such as a pin or a bolt is placed through the corresponding holes 124 in the mounting plates and vertical member 102 to secure the bracket 118 in place. An engagement member 126 is disposed on an opposing end of the body 120. The engagement member 126 is configured to contact the tree stand. In this configuration, the engagement member 126 is generally L-shaped so as to present a vertically extending stop surface and a horizontally extending support surface that intersect at an approximate right angle.

A second bracket embodiment 128 is shown in FIG. 5. Second bracket 128 comprises a horizontally oriented bracket body 130 comprised of a section of tubing. One end of the body 130 has mounting plates 132 disposed on opposing side surfaces, thereby defining a mounting groove or channel for mounting on the vertical support member 102. Holes 134 are provided in the mounting plates 122 that correspond to the holes 106 in the vertical member. A fastener, such as a pin or a bolt is placed through the corresponding holes 134 in the mounting plates 132 and vertical member 102 to secure the bracket 128 in place. An engagement member 138 is disposed on an opposing end of the body 130 and configured to contact the tree stand. In this configuration, the engagement member 138 presents a vertically extending stop surface and a horizontally extending support surface that intersect at an approximate right angle. In top plan view, the engagement member 138 is in a slight V-shape, with the oblique angle formed between the respective halves of the V-shape diverging as they extend towards the vehicle.

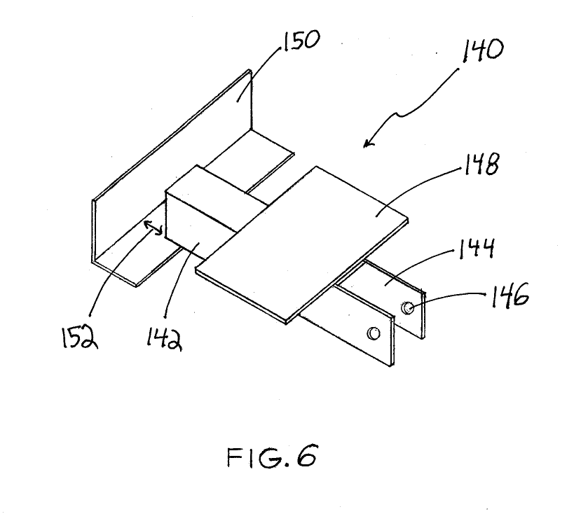

A third bracket embodiment 140 is shown in FIG. 6. Third bracket 140 comprises a horizontally oriented bracket body 142 comprised of a section of tubing. One end of the body 142 has mounting plates 144 disposed on opposing side surfaces, thereby defining a mounting groove or channel for mounting on the vertical support member 102. Holes 146 are provided in the mounting plates 144 that correspond to the holes 106 in the vertical member 102. A fastener, such as a pin or a bolt is placed through the corresponding holes in the mounting plates 144 and vertical member to secure the bracket 140 in place. A scaffold support plate 148 is disposed on the top of the body 142. The scaffold support plate is generally planar. An engagement member 150 is disposed on an opposing end of the body 142 and configured to engage the tree stand. In this configuration, the engagement member 150 presents a vertically extending stop surface and an inwardly horizontally extending support surface that intersects at an approximate right angle, thereby forming an inset 152 between an end of the body 142 and the horizontally extending surface of the engagement member 150. It is understood that the configurations of the brackets may be changed from the examples provided herein to adapt to various types of tree stands without departing from the scope of the invention.

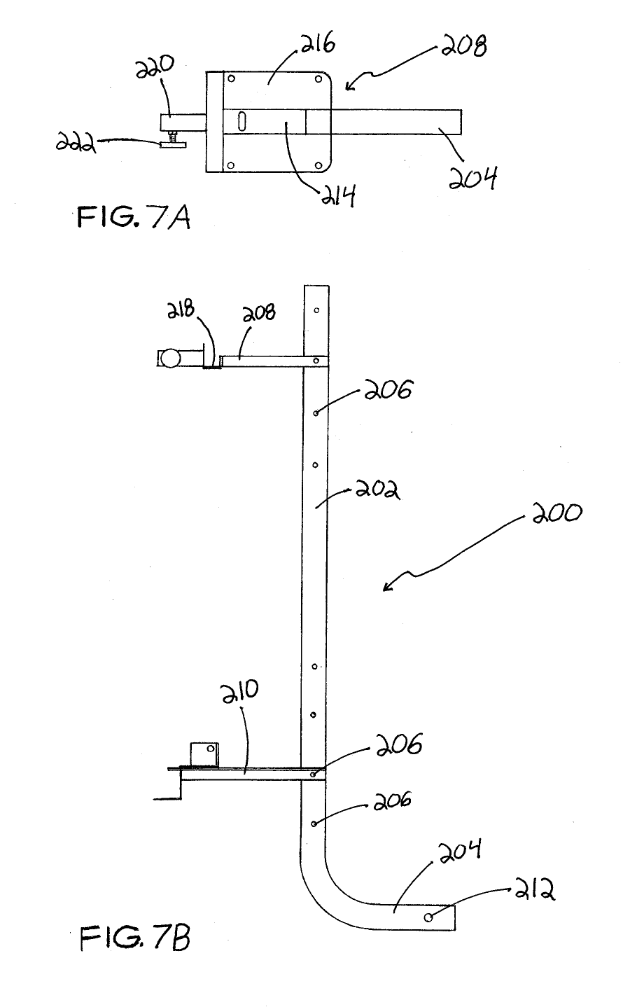

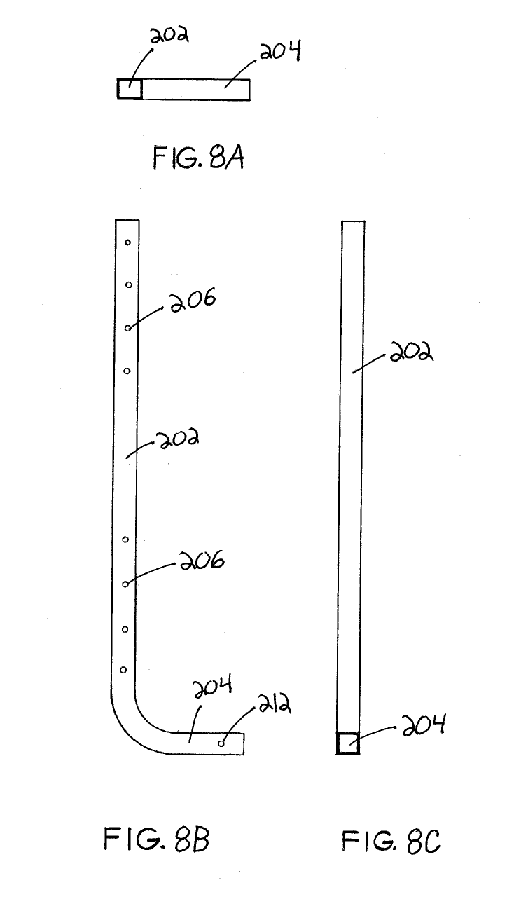

Referring to FIGS. 7A, 7B, 8A, 8B and 8C, another embodiment of a tree stand carrier is shown. Tree stand carrier 200 comprises a vertical support member 202 extending in a generally vertical direction with a curved lower portion terminating in a horizontally extending hitch connecting portion 204. The vertical support member 202 is a tubular member having a square cross section. It is understood, however, that other shapes and styles of members may be used without departing from the scope of the invention. The vertical member 202 has a plurality of holes 206 provided on corresponding sides, to which an upper support bracket 208 and a lower support bracket 210 are mounted using fasteners, such as bolts or pins. The plurality of holes 206 facilitate adjustment of locations of the upper 208 and lower 210 brackets to facilitate use with a variety of tree stand configurations and with a variety of vehicles. Holes 212 are defined in the sidewalls of the hitch connecting portion 204 to facilitate connection with a receiving hitch on a vehicle.

The tree stand carrier 200 may be configured to accept a variety of different tree stands by varying the relative placement and configuration of the support brackets. Referring to FIGS. 7A, 9A, 9B and 9C, a first bracket 224 embodiment is shown. The first bracket embodiment 224 comprises a horizontally oriented central body portion 214 and support plates 216 disposed laterally on either side of the body 214. A vertical member mounting channel is formed by the bounding of the plates 216 and body 214. A retention groove is defined in a retention plate portion 218 formed on an end opposing the mounting channel. The retention groove 218 is configured to receive and restrain a portion of the tree stand.

The first bracket embodiment 224 also may have an extension arm engagement portion 220 protruding outwardly from the retention plate 218. A fastener 222, such as a portion of threaded bolt with a threaded cap, is disposed in a lateral direction so that mounting holes from an engagement arm can be secured over the threaded portion and secured in place with the cap or nut. A plurality of fastening holes 226 may be defined in various portions, such as the support plates 216, in order to facilitate securing with bungee cords, rope, ties or other securing means that a user may wish to employ.

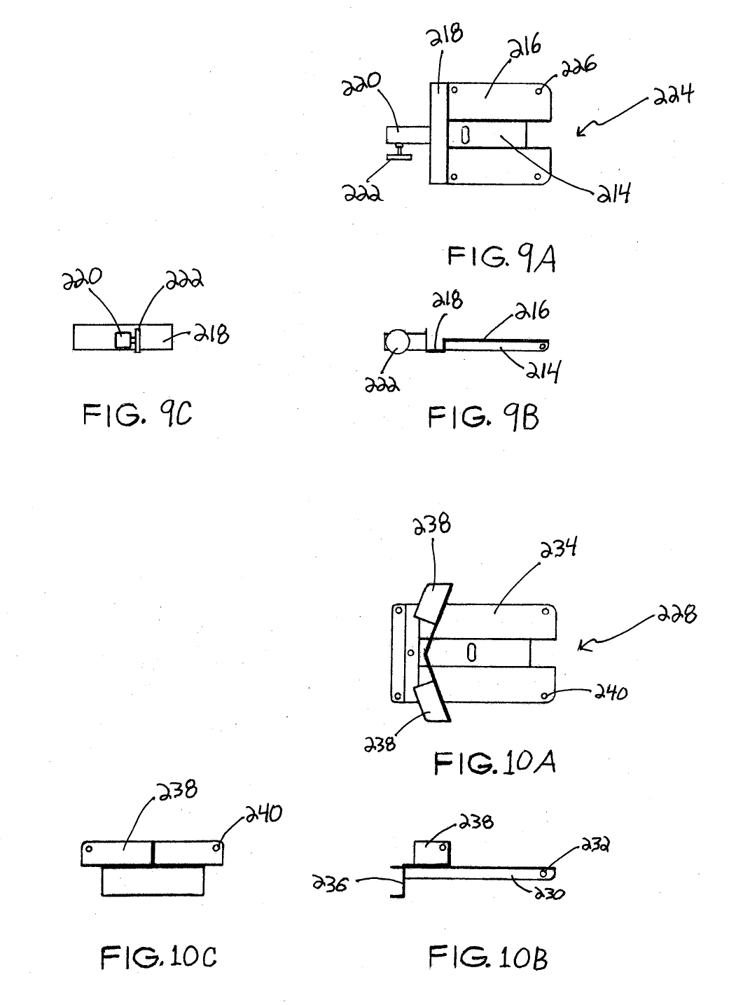

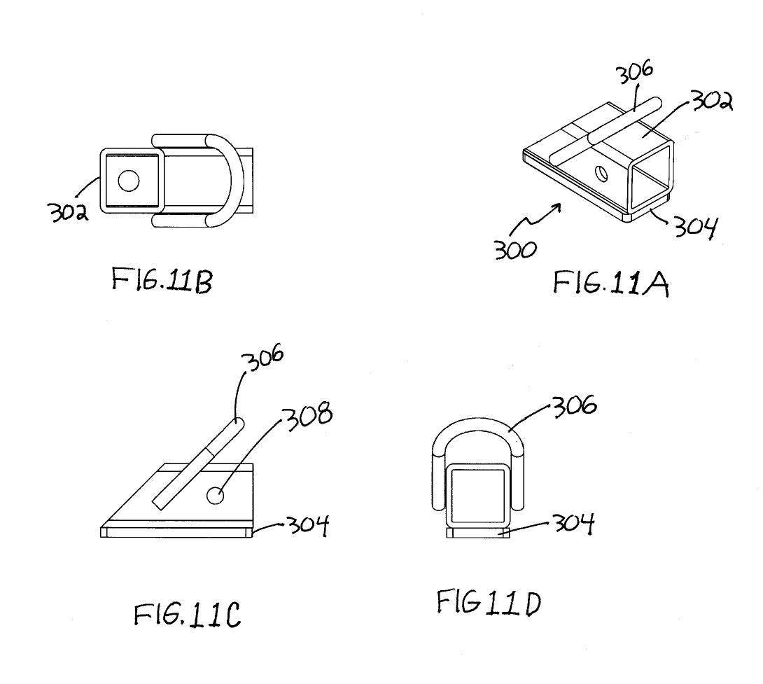

Referring to FIGS. 10A, 10B and 10C, a second bracket 228 embodiment is shown. The second bracket 228 comprises a horizontally oriented central body portion 230 and support plates 234 disposed laterally on either side of the body 230. A vertical member mounting channel is defined by the bounding of the plates 234 and body 230. A mounting hole 232 is defined on either side of the mounting opening to facilitate securing of the bracket 228 to the vertical member. An engagement groove is defined in an engagement plate portion 236 formed on an end opposing the mounting channel. The engagement groove 236 is configured to receive and restrain a portion of the tree stand.

The second bracket 228 also has a frame engagement member 238 extending upwardly from body 230. The frame engagement member 238 in top plan view is in a slight V-shape with each joined at an oblique angle and diverging as it extends toward the vehicle. A plurality of fastening holes 240 may be defined in various portions, such as the support plates 234, in order to facilitate securing with bungee cords, rope, ties or other securing means that a user may wish to employ. It is understood that the configurations of the brackets may be changed to adapt to various types of tree stands without departing from the scope of the invention.

The various tree stand carrier components may be constructed of steel. In one embodiment, 12-gauge steel is used and portions of the brackets are welded together. However, it is contemplated that the various components can be constructed of high strength plastic, carbon fiber, composites, fiberglass or a hybrid of multiple materials.

Referring to FIGS. 11A, 11B, 11C and 11D, a receiver hitch 300 according to one embodiment is shown. The receiver hitch 300 is typically bolted or welded to a strong portion of a vehicle, such as a frame or a differential housing. The receiver hitch 300 comprises a receiver tube 302 disposed on a receiver bolt plate 304. The receiver tube 302 has an opening in an end facing away from the vehicle and is sized and shaped to accept a receiver hitch extension of corresponding size and shape. The bolt plate 304 is secured to the vehicle. A tow loop 306 extends upwardly from the tube 302 at an oblique angle with respect to the plate 304. The tow loop 306 may be used to connect fastening devices, such as rope, straps and bungee cords that a user may utilize to secure the tree stand to the tree stand transporter. The receiver hitch 300 in one embodiment is constructed of steel and the component parts are welded together.

In use, the tree stand transporter or carrier in particular embodiments attaches to a standard two-inch receiver hitch located on an all terrain vehicle or other type of vehicle. The tree stand is taken down, the ladder sections are hung on the transporter, the platform is hung on the transporter, the tree stand components are secured and then the user safely and efficiently transports the tree stand through fields, woods, swamps and water as necessary to reach a desired destination.

The tree stand transporter frees up stowage space inside of the vehicle and also permits a hunter to use a vehicle to transport a tree stand that otherwise would not be able to fit the stand inside of the vehicle.

The tree stand transporter or carrier system of particular embodiments also permits hunters to assemble portions of tree stands and transport those partially assembled portions to a desired location, rather than taking the unassembled stand pieces (often still in their original box) into the woods and performing all assembly there. The ability to avoid significant on-site assembly of individual pieces eliminates the risk of piece loss, frustration, time loss and tool carrying that would otherwise be required. The tree stand transporter or carrier system of particular embodiments also eliminates the need to make multiple trips to the hunting location, such as in the woods, during booth setup and take down procedures.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A tree stand transport system, comprising:
a vertical support member extending in a generally vertical direction and including a generally vertically extending portion and a generally horizontally extending hitch connecting portion configured to be received in a receiver hitch on a vehicle; and
a support bracket disposed on the vertical support member.

2. The tree stand transport system of claim 1, wherein the support bracket comprises:
a horizontally oriented bracket body having a vertical support member attachment end and a tree stand engagement end;
a pair of mounting plates disposed on a vertical support member attachment end; and
a tree stand engagement member disposed on the tree stand engagement end.

3. The tree stand transport system of claim 2, wherein the tree stand engagement member includes a vertically extending stop surface and a horizontally extending support surface that intersect at an approximate right angle.

4. The tree stand transport system of claim 3, wherein the horizontally extending support surface is generally straight in a top view.

5. The tree stand transport system of claim 3, wherein the horizontally extending support surface is generally V-shaped in a top view such that oblique angle is defined between a respective first half and second half with the respective halves of the V-shape diverging as they extend towards the vehicle.

6. The tree stand transport system of claim 2, wherein the support bracket further comprises a scaffold support plate disposed on the horizontally oriented bracket body intermediate the vertical support member attachment end and the tree stand engagement end.

7. The tree stand transport system of claim 2, wherein the tree stand engagement member includes a vertically extending stop surface and an inwardly horizontally extending support surface that intersects the vertically extending stop surface at an approximate right angle, thereby forming an inset between the tree stand engagement end and the horizontally extending surface of the tree stand engagement member.

8. The tree stand transport system of claim 2, wherein the support bracket further comprises:
a pair of support plates extending laterally from the bracket body intermediate the vertical support member attachment end and the tree stand engagement end; and
a retention groove defined in a retention plate portion provided to the tree stand engagement end.

9. The tree stand transport system of claim 2, wherein the support bracket further comprises an extension arm engagement portion extending outwardly from the tree stand engagement end and including a fastener disposed thereon.

10. The tree stand transport system of claim 1, wherein the vertical support member is constructed of metal.

11. The tree stand transport system of claim 1, wherein the vertical support member includes a curved portion located between the generally vertically extending portion and the generally horizontally extending hitch connecting portion.

12. The tree stand transport system of claim 1, wherein the generally vertically extending portion and the generally horizontally extending hitch connecting portion intersect in an approximate right angle.

13. The tree stand transport system of claim 1, wherein the generally vertically extending portion and the generally horizontally extending hitch connecting portion intersect in an approximate right angle.

14. A tree stand transport system, comprising:
a vehicle having a receiver hitch disposed thereon; and
a tree stand carrier secured to the receiver hitch, comprising:
a vertical support member extending in a generally vertical direction and including a generally vertically extending portion and a generally horizontally extending hitch connecting portion configured to be received in the receiver hitch; and
a first tree stand support bracket disposed on the vertical support member.

15. The tree stand transport system of claim 14, further comprising a second tree stand support bracket disposed on the vertical support member.

16. The tree stand transport system of claim 15, further comprising a tether extending between the receiver hitch and the lower support bracket.

17. The tree stand transport system of claim 14, wherein the receiver hitch comprises:
a receiver plate;
a receiver tube disposed on the receiver plate and defining an opening facing away from the vehicle; and
a tow loop extending upwardly from the receiver tube at an oblique angle with respect to the receiver plate.

18. A method of transporting a tree stand with a vehicle having a receiver hitch disposed thereon, the method comprising
inserting a horizontally extending portion of tree stand support member into the receiver hitch of the vehicle, the tree stand having a first support bracket fastened to the tree stand support member;
disposing the tree stand on the first support bracket.

19. The method of claim 18, further comprising disposing the tree stand on a second support bracket that is fastened to the tree stand support member.

20. The method of claim 19, further comprising tethering the tree stand at a position adjacent the second support bracket to the receiver hitch.
